(19) United States
(12) Patent Application Publication
(10) Pub. No.: US 2020/0212711 A1
(43) Pub. Date: Jul. 2, 2020

(54) POWER DISTRIBUTION SYSTEM

(71) Applicant: NABTESCO CORPORATION, Tokyo (JP)

(72) Inventors: Takashi OGAWA, Tokyo (JP); Tomoaki SAWACHIKA, Tokyo (JP); Tomoyuki YOKOGAWA, Tokyo (JP)

(21) Appl. No.: 16/725,259

(22) Filed: Dec. 23, 2019

(30) Foreign Application Priority Data
Dec. 27, 2018 (JP) 2018-245553

(51) Int. Cl. H02J 13/00; H02M 7/797

(52) U.S. Cl. CPC H02J 13/00002; H02M 7/797

(57) ABSTRACT

A power distribution system includes: a distribution unit that splits a supply AC current Ip from an external AC power supply 2 into a first distributed AC current and a second distributed AC current and distributes the first distributed AC current to a first load; a current monitoring unit that monitors the supply AC current Ip; a bidirectional AC-DC converter that converts, when operated as an AC-DC converter, the second distributed AC current distributed from the distribution unit into a supply DC current and supplies the supply DC current to a second load 5 and that converts, when operated as a DC-AC inverter, a regenerative DC current from the second load into a regenerative AC current and supplies the regenerative AC current to the first load; and a control unit that controls the bidirectional AC-DC converter based on the supply AC current Ip monitored by the monitoring unit.

### CROSS REFERENCE TO RELATED APPLICATIONS

The present application claims priority under 35 U.S.C. § 119 to Japanese Patent Application No. 2018-245553, filed on Dec. 27, 2018, the entire contents of which are incorporated herein by reference.

### BACKGROUND OF THE INVENTION

### 1. Field of the Invention

The present invention relates to a power distribution system.

### 2. Description of the Related Art

In related-art power systems, regenerative energy generated by a motor has been self-consumed by a regenerative resistance, etc. or stored in a storage battery by a DC current. Recently, however, power regeneration DC power supply devices provided with both a DC power supply function and an electronic load function and capable of returning regenerative energy directly to the power system have been commercialized.

[Patent literature 1] JP2012-175834

Power regeneration DC power supply devices currently in use are designed to operate with the power factor=1 based on the supply of industrial line power at 50 Hz-60 Hz. In this case, the regenerative energy is uniformly returned to the system with the power factor=−1. In other words, the phase of the regenerative current is controlled so that it is always opposite to the supply AC voltage.

In variable AC power supplies of a high frequency of 400 Hz-800 Hz that are used in aircraft, etc., however, the phases of the supply AC voltage and supply AC current do not necessarily match so that the operation with the power factor=1 is not guaranteed. In this case, the efficiency of regeneration drops if the regenerative energy is uniformly returned to the system with the power factor=−1. Aircraft applications particularly call for size and weight reduction of the source of power so that it is desired to use regenerative energy as efficiently as possible.

Patent literature 1 teaches using a line voltage at the terminal to compensate an unbalanced voltage and control the power factor, when the three-phase unbalanced voltage is unknown or cannot be directly measured. The document also shows that power can be regenerated by the output of a three-phase converter by setting the power factor to −1. However, the disclosed technology cannot control the regenerative current based on the power factor of the AC line in a power distribution system in which the power factor=1 is not realized.

### SUMMARY OF THE INVENTION

The embodiments address the above-described issue, and a general purpose thereof is to use regenerative energy efficiently in a power distribution system.

A power distribution system according to an embodiment of the present invention includes: a distribution unit that splits a supply AC current from an external AC power supply into a first distributed AC current and a second distributed AC current and distributes the first distributed AC current to a first load and distributes the second distributed AC current to a bidirectional AC-DC converter; a current monitoring unit that monitors the supply AC current; a bidirectional AC-DC converter that converts, when operated as an AC-DC converter, the second distributed AC current distributed from the distribution unit into a supply DC current and supplies the supply DC current to a second load and that converts, when operated as a DC-AC inverter, a regenerative DC current from the second load into a regenerative AC current and supplies the regenerative AC current to the first load; and a control unit that controls the bidirectional AC-DC converter based on the supply AC current monitored by the monitoring unit.

Optional combinations of the aforementioned constituting elements, and implementations of the invention replacement of constituting elements in the form of methods, devices, programs, and transitory or non-transitory recording mediums storing programs, systems, etc. may also be practiced as optional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a principle of a power distribution system according to an embodiment;

FIG. 2 is a graph showing the supply AC voltage, the supply AC current, and the first distributed AC current occurring when the second distributed AC current is 0;

FIG. 3 is a graph showing the supply AC voltage, the supply AC current, and the first distributed AC current occurring when regenerative current control with the power factor=−1 is performed while a 40% regenerative current is generated in response to the first distributed AC current;

FIG. 4 is a graph showing the supply AC voltage, the supply AC current, and the first distributed AC current occurring when regenerative current control with the power factor=−0.8 is performed while a 40% regenerative current is generated in response to the first distributed AC current;

FIG. 5 is a graph showing the supply AC voltage, the supply AC current, and the first distributed AC current occurring when regenerative current control with the power factor=−0.8 is performed while a 100% regenerative current is generated in response to the first distributed AC current;

FIG. 6 is a block diagram showing a configuration of the power distribution system according to the first embodiment;

FIG. 7 is a graph showing an example of control of the bidirectional AC-DC converter;

FIG. 8 is a graph showing another example of control of the bidirectional AC-DC converter;

FIG. 9 is a block diagram showing a configuration of the power distribution system according to the second embodiment;

FIG. 10 is a block diagram showing a configuration of the power distribution system according to variation 1; and

FIG. 11 is a block diagram showing a configuration of the power distribution system according to variation 2.

### DETAILED DESCRIPTION OF THE INVENTION

The invention will now be described by reference to the preferred embodiments. This does not intend to limit the scope of the present invention, but to exemplify the invention.

Hereinafter, the invention will be described based on preferred embodiments with reference to the accompanying drawings. Identical or like constituting elements, members, processes shown in the drawings are represented by identical symbols and a duplicate description will be omitted.

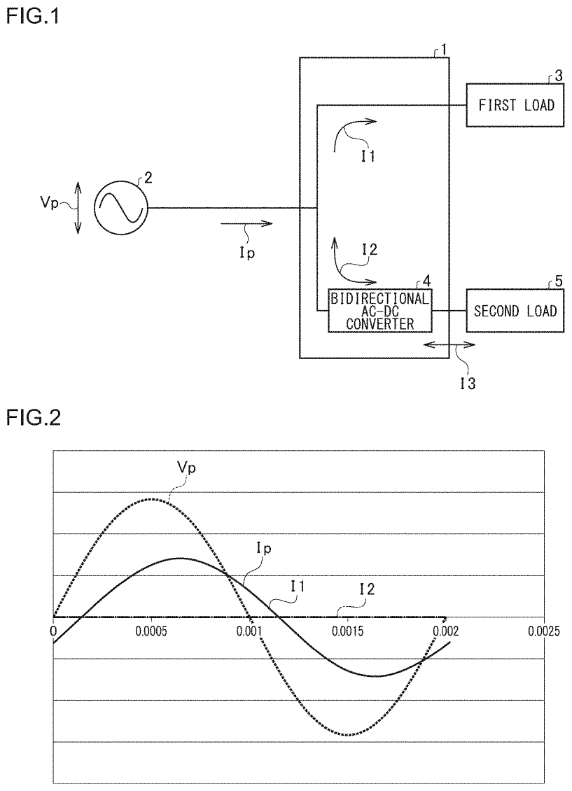

An explanation of the basic knowledge will be given with reference to FIG. 1 before describing a specific embodiment.

FIG. 1 shows a principle of a power distribution system 1 according to an embodiment. The input side of the power distribution system 1 is connected to an AC power supply 2 that supplies power. Meanwhile, the output side of the power distribution system 1 is connected to a first load 3 to which power is supplied and is also connected to a second load 5 via a bidirectional AC-DC converter 4. An AC power is supplied to the first load 3. Meanwhile, a DC power is supplied to the second load 5.

The bidirectional AC-DC converter 4 has both a function of converting an AC current into a DC current and a function of converting a DC current into an AC current. Hereafter, an operation mode in which the bidirectional AC-DC converter 4 converts an AC current into a DC current will be referred to as “AC-DC converter operation mode”. Further, an operation mode in which the bidirectional AC-DC converter 4 converts a DC current into an AC current will be referred to as “DC-AC inverter operation mode”.

The bidirectional AC-DC converter 4 has a regenerative function of supplying regenerative energy generated in the second load 5 to the first load 3. In other words, in the DC-AC inverter operation mode, the bidirectional AC-DC converter 4 converts the regenerative DC current from the second load 5 into a regenerative AC current and supplies the regenerative AC current to the first load 3.

The supply AC current Ip from the AC power supply 2 is input to the power distribution system 1. The power distribution system 1 splits the supply AC current into a first distributed AC current I1 and a second distributed AC current I2, distributing the first distributed AC current I1 to the first load 3 and distributing the second distributed AC current I2 to the bidirectional AC-DC converter 4. In other words, the relationship Ip=I1+I2 holds.

In the AC-DC converter operation mode, the bidirectional AC-DC converter 4 converts the second distributed AC current I2 into a supply DC current I3 and supplies the supply DC current I3 to the second load 5. In the DC-AC inverter operation mode, on the other hand, the bidirectional AC-DC converter 4 converts the regenerative DC current I3 from the second load 5 into the regenerative AC current I2 and supplies the regenerative AC current I2 to the first load 3. In other words, the current I2 will be a regenerative current when the bidirectional AC-DC converter 4 is operated in the DC-AC inverter operation mode.

FIG. 2 shows the supply AC voltage Vp, the supply AC current Ip, and the first distributed AC current I1 occurring when the second distributed AC current I2 is 0. It is assumed here that the AC power supply is operated with the power factor=0.8. In other words, the supply AC current Ip is delayed with the power factor=0.8 relative to the supply AC voltage Vp.

Referring to FIG. 2, the second distributed AC current I2 is 0 so that the first distributed AC current I1 matches the supply AC current Ip.

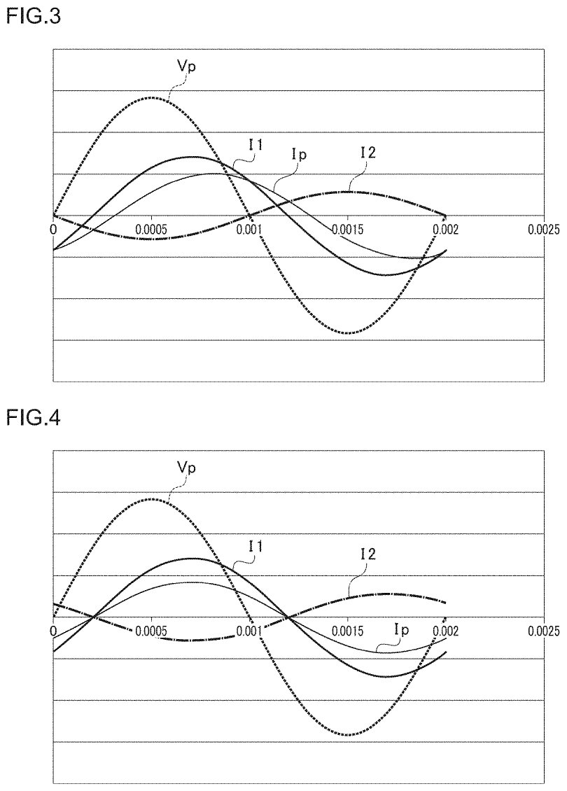

FIG. 3 shows that regenerative energy is generated in the second load 5, and the regenerative AC current I2 is supplied from the second load 5 to the first load 3. The average of the magnitude of the second distributed AC current I2 is 40% the average of the magnitude of the first distributed AC current I1.

FIG. 3 shows that the regenerative AC current I2 is supplied from the second load 5 to the first load 3 with the power factor=−1. In other words, the phase of the regenerative AC current I2 is opposite to the phase of the supply AC voltage Vp. Therefore, the supply AC current Ip is delayed from the inverted phase of the regenerative AC current I2 with the power factor=0.8. In this case, the supply AC current Ip shows a drop of about 50% as compared with the case of FIG. 2, revealing that the regenerative energy is supplied to the first load 3 at a certain efficiency.

The supply of the regenerative current with the power factor=−1 described above is performed in an ordinary power regeneration DC power supply device. We have realized that the efficiency of supplying a regenerative current can be improved by supplying a regenerative current based on the phase of the supply AC voltage Vp instead of supplying a regenerative current with the power factor=−1.

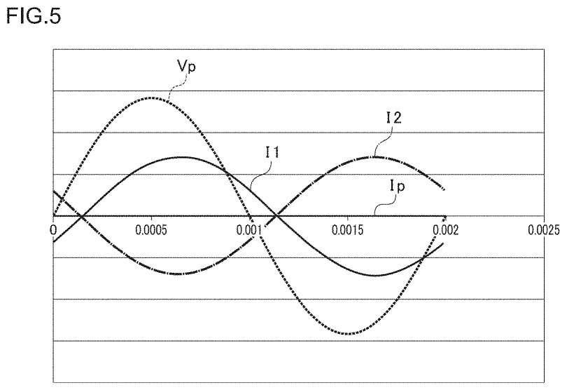

FIG. 4 shows that regenerative energy like that of FIG. 3 is generated in the second load, and the regenerative AC current I2 is supplied from the second load 5 to the first load 3. The difference is that, in FIG. 4, the regenerative AC current I2 is controlled to have a power factor=−0.8. In other words, the phase of the regenerative AC current I2 is controlled to be opposite to the phase of the supply AC current Ip. As shown FIG. 4, the supply AC current Ip shows a further drop as compared with the case of FIG. 3. In other words, the same regenerative energy as that of FIG. 3 is supplied to the first load 3 more efficiently in FIG. 4.

FIG. 5 shows that regenerative energy corresponding to the first distributed AC current I1 is generated in the second load 5 and is supplied to the first load 3 with the power factor=−0.8. In this case, the supply AC current Ip is 0 as shown in FIG. 5. In other words, FIG. 5 shows that ideal regenerative current supply, in which the power required by the first load 3 is fully covered by the regenerative energy, is realized.

As described above, according to the principle of the embodiment, regenerative energy can be supplied efficiently to the load even when the source of the AC power is not operated with the power factor=1.

### First Embodiment

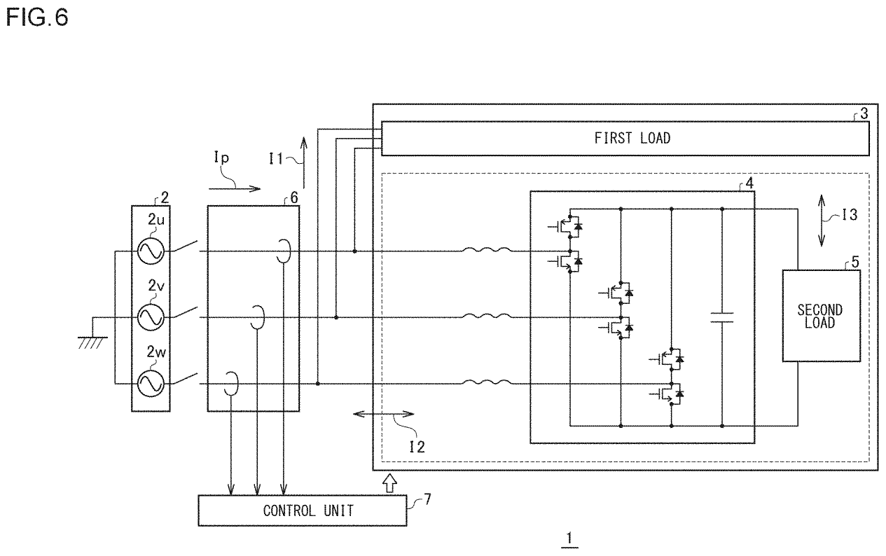

FIG. 6 is a block diagram showing a configuration of the power distribution system 1 according to the first embodiment. The power distribution system 1 includes a current monitoring unit 6, a bidirectional AC-DC converter 4, and a control unit 7.

A supply AC current Ip is supplied to the power distribution system 1 from an external three-phase AC power supply 2. The AC power supply 2 includes a U-phase power supply 2U, a V-phase power supply 2V, and a W-phase power supply 2W.

The current monitoring unit 6 monitors the supply AC current Ip and transmits the current waveforms of the U-phase, V-phase, and W-phase of the supply AC current Ip monitored to the control unit 7.

The power distribution system 1 splits the supply AC current into a first distributed AC current I1 and a second distributed AC current I2. The power distribution system 1 delivers the first distributed AC current I1 to the first load 3 and delivers the second distributed AC current I2 to the bidirectional AC-DC converter 4.

In the AC-DC converter operation mode, the bidirectional AC-DC converter 4 converts the second distributed AC current I2 into a supply DC current I3 and supplies the supply DC current I3 to the second load 5. In the DC-AC inverter operation mode, the bidirectional AC-DC converter 4 converts the regenerative DC current I3 from the second load 5 into the regenerative AC current I2 and supplies the regenerative AC current I2 to the first load 3.

The control unit 7 controls the bidirectional AC-DC converter 4 based on the supply AC current Ip monitored by the current monitoring unit 6. More specifically, the control unit 7 controls the bidirectional AC-DC converter 4 so that the phase of the regenerative AC current I2 is opposite to the phase of the supply AC current Ip.

According to the embodiment, it is possible to supply the regenerative energy to the load efficiently even when the source of the AC power is not operated with the power factor=1.

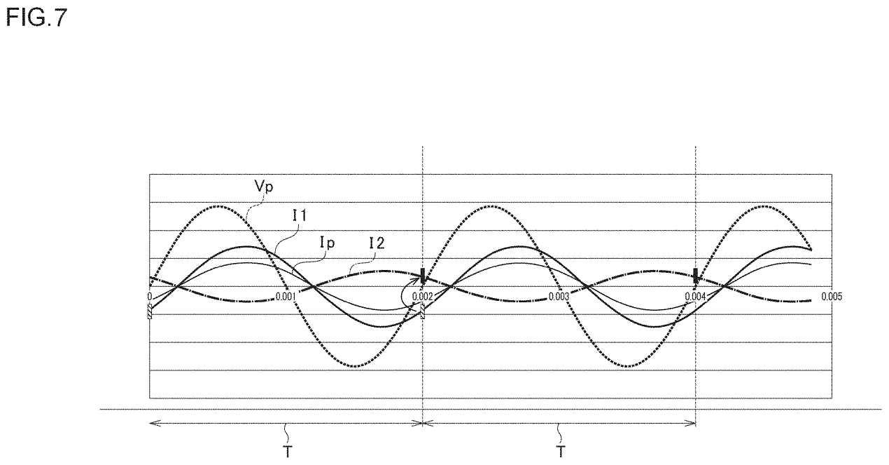

FIG. 7 shows a first example of control of the bidirectional AC-DC converter 4 by the control unit 7. The control unit 7 stores the waveform of the supply AC current Ip monitored by the current monitoring unit 6 for one period T1. The waveform for the one period is fed back to the bidirectional AC-DC converter 4, and the phase of the regenerative AC current I2 is controlled accordingly so as to be opposite to the phase of the supply AC current Ip in the next period.

According to the control of the first example, the phase of the regenerative AC current I2 is controlled by using the waveform of the supply AC current Ip for one period so that accurate control is possible.

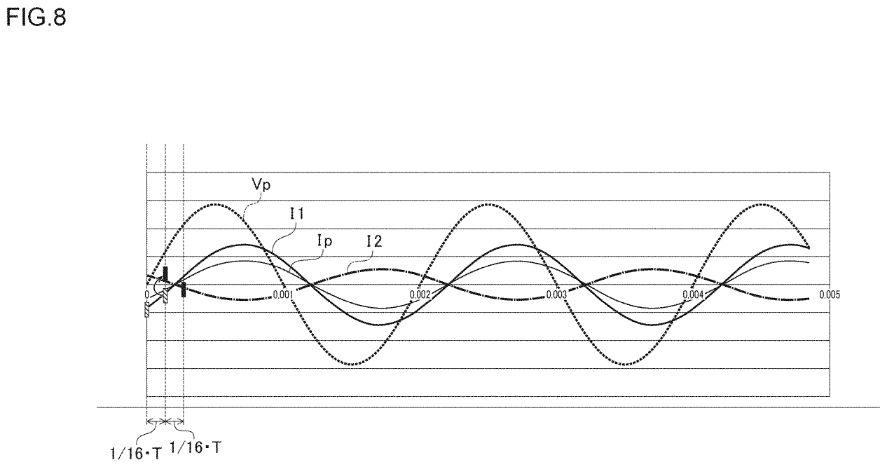

FIG. 8 shows a second example of control of the bidirectional AC-DC converter 4 by the control unit 7. The control unit 7 stores the waveform of the supply AC current Ip monitored by the current monitoring unit 6 for 1/16 of the period T. By feeding back the waveform for 1/16 of the period to the bidirectional AC-DC converter 4, the phase of the regenerative AC current I2 is controlled to be opposite to the phase of the supply AC current Ip.

According to the second example of control, the phase of the regenerative AC current I2 is controlled in units of time equal to 1/16 of the period of the supply AC current Ip so that speedy control is possible.

### Second Embodiment

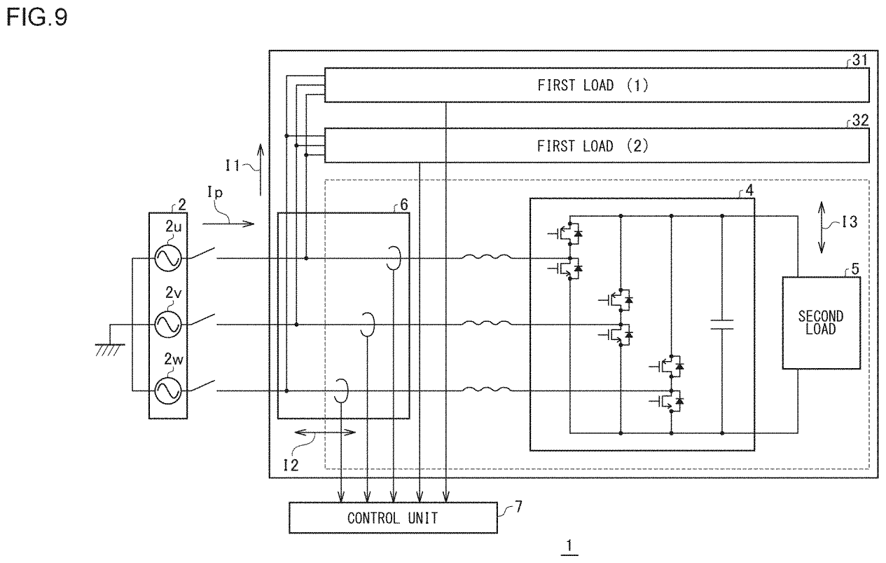

FIG. 9 is a block diagram showing a configuration of the power distribution system 1 according to the second embodiment. The power distribution system 1 includes a current monitoring unit 6, a bidirectional AC-DC converter 4, and a control unit 7.

A supply AC current Ip is supplied to the power distribution system 1 from an external three-phase AC power supply 2. The AC power supply 2 includes a U-phase power supply 2U, a V-phase power supply 2V, and a W-phase power supply 2W.

The power distribution system 1 splits the supply AC current Ip into a first distributed AC current I1 and a second distributed AC current I2. The power distribution system 1 further splits the first distributed AC current I1 and distributes the split currents to the first load (1) 31 and the first load (2) 32. The power distribution system 1 delivers the second distributed AC current I2 to the bidirectional AC-DC converter 4.

The current monitoring unit 6 monitors the first distributed AC current I1 and the second distributed AC current I2 and transmits the current waveforms of the U-phase, V-phase, and W-phase of the first distributed AC current I1 and the second distributed AC current I2 monitored to the control unit 7.

In the AC-DC converter operation mode, the bidirectional AC-DC converter 4 converts the second distributed AC current I2 into a supply DC current I3 and supplies the supply DC current I3 to the second load 5. In the DC-AC inverter operation mode, the bidirectional AC-DC converter 4 converts the regenerative DC current from the second load 5 into the regenerative Ac current and supplies the regenerative AC current to the first load (1) 31 and the second load (2) 32.

The control unit 7 finds a sum of the first distributed AC current I1 and the second distributed AC current I2 monitored by the current monitoring unit 6 and defines the sum as the supply AC current Ip. The control unit 7 controls the bidirectional AC-DC converter 4 based on the supply AC current Ip calculated in this way. More specifically, the control unit 7 controls the bidirectional AC-DC converter 4 so that the phase of the regenerative AC current I2 is opposite to the phase of the supply AC current Ip.

According to the embodiment, it is possible to supply the regenerative energy to the load efficiently even when the source of the AC power is not operated with the power factor=1. The embodiment is particularly useful in a system including a plurality of first loads by supplying regenerative energy to these loads efficiently. Further, the current monitoring unit can measure the first distributed AC current and the second AC distributed current AC instead of measuring the supply AC current directly. Therefore, the flexibility of the configuration is improved.

Described above is an explanation based on an exemplary embodiment. The embodiments are intended to be illustrative only and it will be understood by those skilled in the art that variations and modifications are possible within the claim scope of the present invention and that such variations and modifications are also within the claim scope of the present invention. Therefore, the description in this specification and the drawings shall be treated to serve illustrative purposes and shall not limit the scope of the invention.

### [Variations]

A description will now be given of variations. In the description of the variations, constituting elements and members identical or equivalent to those of the embodiments shall be denoted by the same reference numerals. Duplicative explanations are omitted appropriately and features different from those of the embodiments will be highlighted.

### (Variation 1)

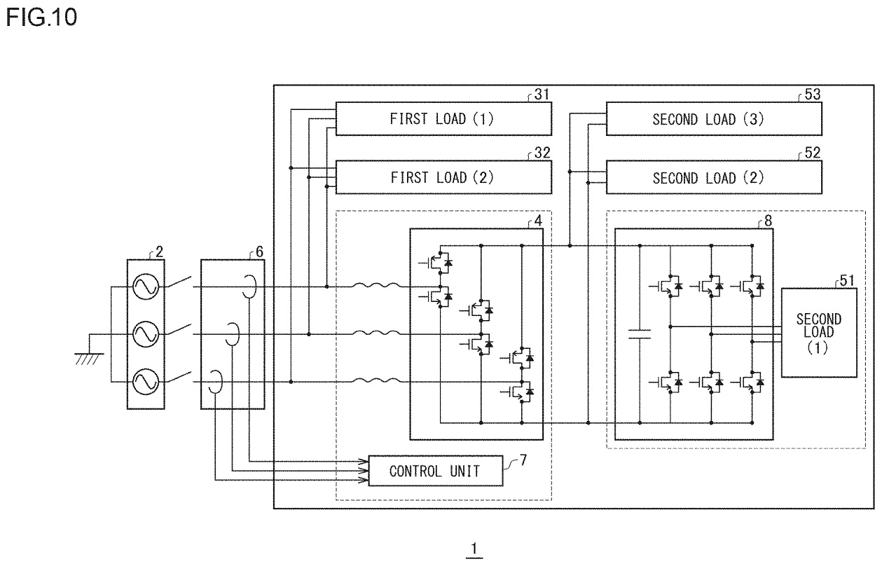

FIG. 10 is a block diagram showing a configuration of the power distribution system 1 according to variation 1. The power distribution system 1 of FIG. 10 differs from the power distribution system 1 of FIG. 6 in that power is distributed to a first load (1) 31, a first load (2) 32, a second load (1) 51, a second load (2) 52, and a second load (3) 53.

The second load (3) 53 is a load driven by an AC power supply. Therefore, a DC-AC inverter 8 for converting the supply DC current supplied from the bidirectional AC-DC converter 4 into an AC current is provided in a stage preceding the second load (3) 53. The other aspects of the configuration and the operation of the power distribution system 1 of FIG. 10 are the same as those of the power distribution system 1 of FIG. 6.

According to this variation, the flexibility in the configuration is improved.

### (Variation 2)

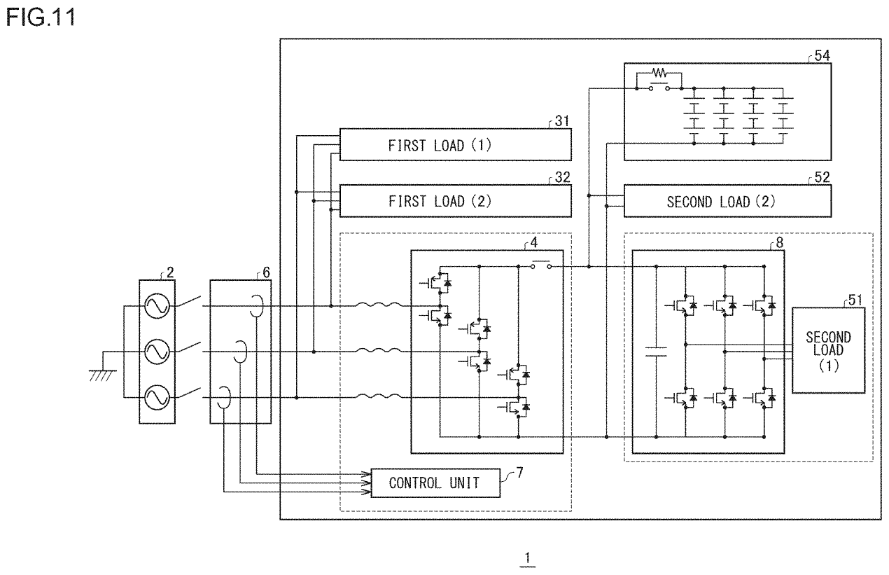

FIG. 11 is a block diagram showing a configuration of the power distribution system 1 according to variation 2. In the power distribution system of FIG. 11, a battery 54 is provided in place of the second load (3) 53 of FIG. 10. A portion of the regenerative current from the second load (1) 51 and the second load (2) 52 is supplied to the battery 54 to charge the battery 54. The other aspects of the configuration and the operation of the power distribution system 1 of FIG. 11 are the same as those of the power distribution system 1 of FIG. 10.

The battery 54 may be discharged according to a desired timing schedule to supply a current to the first load (1) or the second load (2). In the case the first load (1) and the second load (2) are motors, in particular, the battery 54 may supply a current when the motors are started.

According to this variation, the flexibility in the configuration is improved.

Any combination of an embodiment and a variation described above will also be useful as an embodiment of the present invention. A new embodiment created by a combination will provide the combined advantages of the embodiment and the variation as combined.

What is claimed is:

1. A power distribution system comprising:
a distribution unit that splits a supply AC current Ip from an external AC power supply into a first distributed AC current and a second distributed AC current and distributes the first distributed AC current to a first load and distributes the second distributed AC current to a bidirectional AC-DC converter;
a current monitoring unit that monitors the supply AC current Ip;
a bidirectional AC-DC converter that converts, when operated as an AC-DC converter, the second distributed AC current distributed from the distribution unit into a supply DC current and supplies the supply DC current to a second load and that converts, when operated as a DC-AC inverter, a regenerative DC current from the second load into a regenerative AC current and supplies the regenerative AC current to the first load; and
a control unit that controls the bidirectional AC-DC converter based on the supply AC current Ip monitored by the monitoring unit.

2. The power distribution system according to claim 1, wherein
the control unit controls the bidirectional AC-DC converter so that a phase of the regenerative AC current is opposite to a phase of the supply AC current Ip monitored by the monitoring unit.

3. The power distribution system according to claim 1, wherein
the current monitoring unit monitors the supply AC current Ip by finding a sum of the first distributed AC current and the second distributed AC current.

4. The power distribution system according to claim 2, wherein
the current monitoring unit monitors the supply AC current Ip by finding a sum of the first distributed AC current and the second distributed AC current.
